(19) United States
(12) Patent Application Publication
(10) Pub. No.: US 2026/0247471 A1
(43) Pub. Date: Aug. 20, 2026

(54) RADIO RESOURCE CONTROL RECONFIGURATION ERROR HANDLING

(71) Applicant: QUALCOMM Incorporated, San Diego, CA (US)

(72) Inventors: Umesh PHUYAL, San Diego, CA (US); Daniel AMERGA, San Diego, CA (US); Mona AGRAWAL, San Diego, CA (US); Bharat SHRESTHA, San Diego, CA (US); Gavin Bernard HORN, La Jolla, CA (US); Masato KITAZOE, Hachiouji-shi (JP); Sitaramanjaneyulu KANAMARLAPUDI, San Diego, CA (US); Aziz GHOLMIEH, Del Mar, CA (US); Ozcan OZTURK, San Diego, CA (US); Leena ZACHARIAS, San Jose, CA (US)

(21) Appl. No.: 19/054,198

(22) Filed: Feb. 14, 2025

(51) Int. Cl. H04W 76/27; H04W 76/19

(52) U.S. Cl. CPC H04W 76/27; H04W 76/19

(57) ABSTRACT

Various aspects of the present disclosure generally relate to wireless communication. In some aspects, a user equipment (UE) may receive, from a network node, a radio resource control reconfiguration including a set of configuration parameters. The UE may transmit, to the network node, a message indicating failed application of the RRC reconfiguration based on one or more failed configuration parameters of the set of configuration parameters. Numerous other aspects are described.

### FIELD OF THE DISCLOSURE

Aspects of the present disclosure generally relate to wireless communication and specifically relate to techniques, apparatuses, and methods associated with radio resource control reconfiguration error handling.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In a wireless network, radio resource control (RRC) is a protocol within the network control plane that manages communications between a user equipment (UE) and a network node. In some examples, RRC may be responsible for establishing, maintaining, or releasing connections between the UE and the network node. Additionally, RRC may be responsible for configuring radio bearers, broadcasting system information, and ensuring mobility and security. RRC configurations may specify how resources are allocated and optimized for the UE, thereby enabling efficient transitions between the UE's RRC operational modes, including RRC_IDLE (e.g., a low-power state), RRC_CONNECTED (e.g., an active data-transfer state), and RRC_INACTIVE (e.g., a low-power state with quick reactivation). As a result, the RRC configuration may enable the network to balance power efficiency, latency, and connection continuity.

### BRIEF DESCRIPTION OF THE DRAWINGS

FIG. 1 is a diagram illustrating an example of a wireless network.

FIG. 2 is a diagram illustrating an example disaggregated base station architecture.

FIG. 3 is a diagram illustrating an example of a wireless network in which a user equipment (UE) may support additional communication modes.

FIGS. 4A-4B are diagrams illustrating examples of reconfiguration of a radio resource control (RRC) configuration.

FIGS. 5A-5C are diagrams of an example associated with RRC reconfiguration error handling.

FIG. 6 is a flowchart illustrating an example process performed, for example, by a UE.

FIG. 7 is a flowchart illustrating an example process performed, for example, by a network node.

FIGS. 8-9 are diagrams of example apparatuses for wireless communication.

### SUMMARY

Some aspects described herein relate to a user equipment (UE). The UE may include a processing system. The processing system may include one or more processors and one or more code-storing memories coupled with the one or more processors. The processing system may be configured to cause the UE to receive, from a network node, a radio resource control (RRC) reconfiguration including a set of configuration parameters. The processing system may be configured to cause the UE to transmit, to the network node, a message indicating failed application of the RRC reconfiguration based on one or more failed configuration parameters of the set of configuration parameters.

Some aspects described herein relate to a network node. The network node may include a processing system. The processing system may include one or more processors and one or more code-storing memories coupled with the one or more processors. The processing system may be configured to cause the network node to transmit, to a UE, an RRC reconfiguration including a set of configuration parameters. The processing system may be configured to cause the network node to receive, from the UE, a message indicating failed application of the RRC reconfiguration based on one or more failed configuration parameters of the set of configuration parameters.

Some aspects described herein relate to a method of wireless communication performed by a UE. The method may include receiving, from a network node, an RRC reconfiguration including a set of configuration parameters. The method may include transmitting, to the network node, a message indicating failed application of the RRC reconfiguration based on one or more failed configuration parameters of the set of configuration parameters.

Some aspects described herein relate to a method of wireless communication performed by a network node. The method may include transmitting, to a UE, an RRC reconfiguration including a set of configuration parameters. The method may include receiving, from the UE, a message indicating failed application of the RRC reconfiguration based on one or more failed configuration parameters of the set of configuration parameters.

Some aspects described herein relate to a non-transitory computer-readable medium that stores a set of instructions for wireless communication by a UE. The set of instructions, when executed by one or more processors of the UE, may cause the UE to receive, from a network node, an RRC reconfiguration including a set of configuration parameters. The set of instructions, when executed by one or more processors of the UE, may cause the UE to transmit, to the network node, a message indicating failed application of the RRC reconfiguration based on one or more failed configuration parameters of the set of configuration parameters.

Some aspects described herein relate to a non-transitory computer-readable medium that stores a set of instructions for wireless communication by a network node. The set of instructions, when executed by one or more processors of the network node, may cause the network node to transmit, to a UE, an RRC reconfiguration including a set of configuration parameters. The set of instructions, when executed by one or more processors of the network node, may cause the network node to receive, from the UE, a message indicating failed application of the RRC reconfiguration based on one or more failed configuration parameters of the set of configuration parameters.

Some aspects described herein relate to an apparatus for wireless communication. The apparatus may include means for receiving, from a network node, an RRC reconfiguration including a set of configuration parameters. The apparatus may include means for transmitting, to the network node, a message indicating failed application of the RRC reconfiguration based on one or more failed configuration parameters of the set of configuration parameters.

Some aspects described herein relate to an apparatus for wireless communication. The apparatus may include means for transmitting, to a UE, an RRC reconfiguration including a set of configuration parameters. The apparatus may include means for receiving, from the UE, a message indicating failed application of the RRC reconfiguration based on one or more failed configuration parameters of the set of configuration parameters.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, UE, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### DETAILED DESCRIPTION

In a wireless network, radio resource control (RRC) is a protocol within the control plane that manages communications between a user equipment (UE) and a network node. In some examples, RRC may be responsible for establishing, maintaining, or releasing connections between the UE and the network node. Additionally, RRC may be responsible for configuring radio bearers, broadcasting system information, and ensuring mobility and security. RRC configurations may specify how resources are allocated and optimized for the UE, thereby enabling efficient transitions between the UE's RRC operational modes, including RRC_IDLE (e.g., a low-power state), RRC_CONNECTED (e.g., an active data-transfer state), and RRC_INACTIVE (e.g., a low-power state with quick reactivation). As a result, the RRC configuration may enable the network to balance power efficiency, latency, and connection continuity.

Furthermore, the network may utilize an RRC reconfiguration process to setup or modify an RRC configuration. In some examples, the network may perform RRC reconfiguration to establish, modify, or release connections, to perform reconfiguration with a synchronization process, to setup, modify, or release measurements, or to add, modify, or release SCells or cell groups, among other examples. As a result, the network may adapt the RRC configuration according to the UE's unique conditions or to network conditions, among other examples. Accordingly, an RRC reconfiguration may also enable the network to balance power efficiency, latency, and connection continuity.

For example, the network may perform a UE-specific RRC reconfiguration that may focus on tailoring the connection parameters and resource allocations specific to the UE. As a result, a UE-specific RRC reconfiguration may enable the network to optimize resource utilization and maintain quality of service (QoS) for diverse applications, including ultra-reliable low-latency communication (URLLC) or enhanced mobile broadband (eMBB), among other examples. Additionally, the network may update a system information block (SIB) configuration, which might include modifications to timers, constants, or other parameters that impact how one or more UEs manage their connections while in RRC_CONNECTED or RRC_INACTIVE modes. An SIB reconfiguration may be applied on a cell-specific basis (e.g., rather than a UE-specific basis), which may enable updates to one or more UEs located within a cell coverage.

However, where the UE is unable to apply all or part of the network-provided RRC reconfiguration, the RRC reconfiguration may be effectively inoperative. In some examples, the UE may be unable to apply part of the RRC reconfiguration due to hardware limitations, a thermal state or UE-specific power levels (e.g., high-throughput or processor-intensive operations may be curtailed due to rises in temperature or relatively low battery levels), or the UE operating in a multiple subscriber identity module (MSIM) mode (e.g., where active traffic on a secondary subscription (SUB) results in reduced capability for the primary SUB). As a result, where the UE receives a problematic RRC reconfiguration, or where reconfiguration failure occurs, the UE may initiate an RRC connection re-establishment procedure. After an RRC connection re-establishment, the network node may retransmit the RRC reconfiguration. However, the UE may remain unable to successfully apply part or all of the retransmitted RRC reconfiguration. In other words, the UE may continue to receive an RRC reconfiguration that the UE is unable to apply, resulting in a repeated unsuccessful RRC reconfiguration procedure.

Various aspects relate generally to a UE receiving an RRC reconfiguration that includes a set of configuration parameters. The UE may then transmit a message indicating a failed application of the RRC reconfiguration based on one or more failed configuration parameters. Some aspects more specifically relate to skipping a configured transmission of an RRC re-establishment request based on a successful application of one or more of the configuration parameters. In some aspects, the message may include a bitmap identifying one or more of the failed configuration parameters or one or more of the successful configuration parameters. Additionally, each configuration parameter may be included in a configuration parameter group, where the message indicates each configuration parameter group that includes a failed configuration parameter. In some aspects, each configuration parameter is associated with an ignorable parameter type or a non-ignorable parameter type. Additionally, the message may indicate a non-ignorable failed application of the RRC configuration based on one or more of the failed configuration parameters being associated with a non-ignorable parameter type. Furthermore, the UE may skip a configured transmission of an RRC re-establishment request where each failed configuration parameter is associated with an ignorable parameter type, or the UE may transmit an RRC re-establishment request where one or more failed configuration parameters are associated with a non-ignorable parameter type. Additionally, the UE or the network node may identify a set of need codes that include an ignorable need code indicating a set of ignorable parameter types. For example, a new need code may be introduced to a wireless communication standard (e.g., in a definition associated with RRC signaling), where the new need code may indicate whether a field, configuration, or configuration parameter is associated with an ignorable parameter type.

In some aspects, the UE may apply a previously-obtained RRC configuration based on transmission of the message indicating a failed application of the RRC reconfiguration, or the UE may receive an updated RRC reconfiguration including an updated set of configuration parameters. Additionally, the UE may obtain a configuration indicating conditions for transmitting the message, and additionally, the UE may transmit an RRC re-establishment request based on a determination that one or more conditions are not satisfied. In some aspects, the UE may indicate support for reporting a failed application of one or more received RRC reconfigurations.

Particular aspects of the subject matter described in this disclosure can be implemented to realize one or more of the following potential advantages. In some examples, the described techniques can be used to efficiently indicate an unsuccessful application of all or part of an RRC reconfiguration received at a UE, thereby reducing latency due to preventing potential repetition of RRC reconfigurations transmitted to the UE. Additionally, the described techniques may be used to improve spectral efficiency or reduce network traffic by reducing the quantity of potentially unsuccessful RRC reconfiguration messages transmitted to one or more UEs in the network. Furthermore, by transmitting a bitmap identifying the failed configuration parameters, the UE may reduce transmission overhead relative to the transmission of a message indicating the identity of each failed configuration parameter and any accompanying information. In some examples, where each configuration parameter is associated with an ignorable or a non-ignorable parameter type, the UE may skip an RRC re-establishment request for parameters of relatively less importance, thereby conserving power and reducing network congestion due to a reduced quantity of communications between the UE and the network node.

5G New Radio (NR) may support eMBB access, Internet of Things (IoT) networks or reduced capability (RedCap) device deployments, URLLC applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

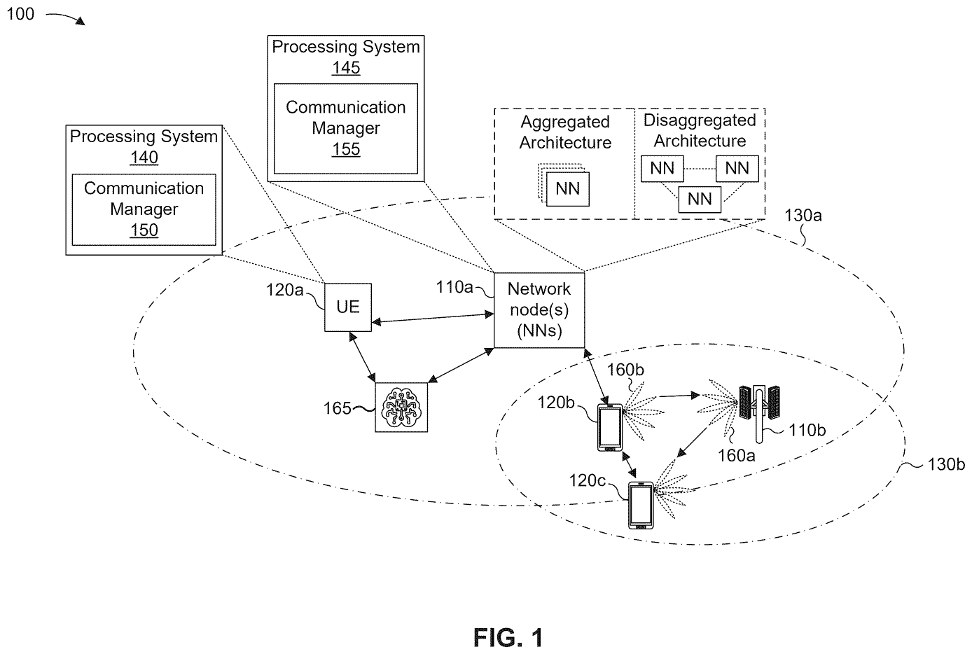

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific conditions associated with one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node 110, an RRC reconfiguration including a set of configuration parameters; and transmit, to the network node 110, a message indicating failed application of the RRC reconfiguration based on one or more failed configuration parameters of the set of configuration parameters. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, an RRC reconfiguration including a set of configuration parameters; and receive, from the UE 120, a message indicating failed application of the RRC reconfiguration based on one or more failed configuration parameters of the set of configuration parameters. Additionally, or alternatively, the communication manager 155 may perform one or more other operations described herein.

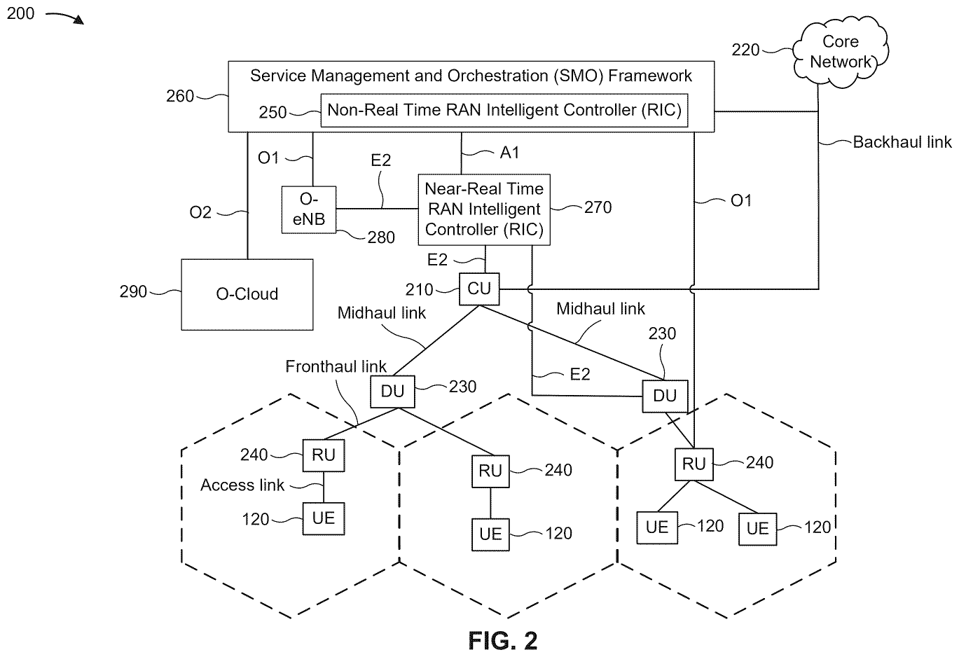

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

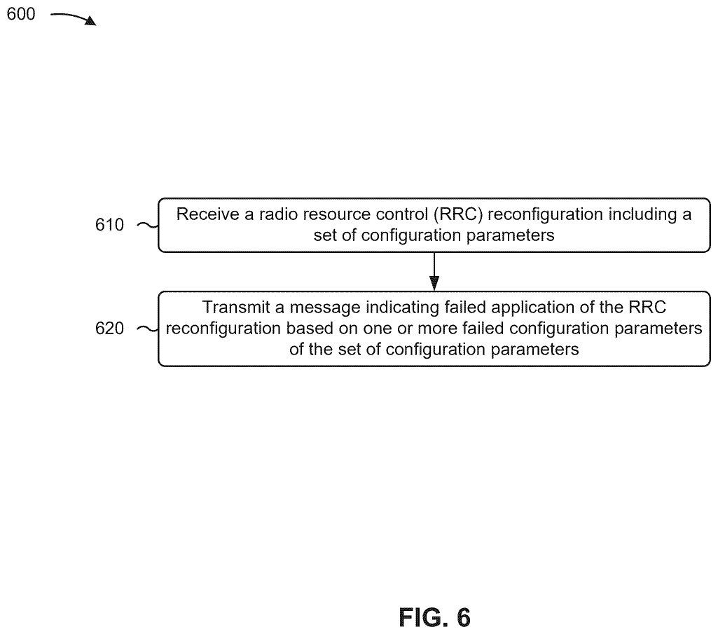

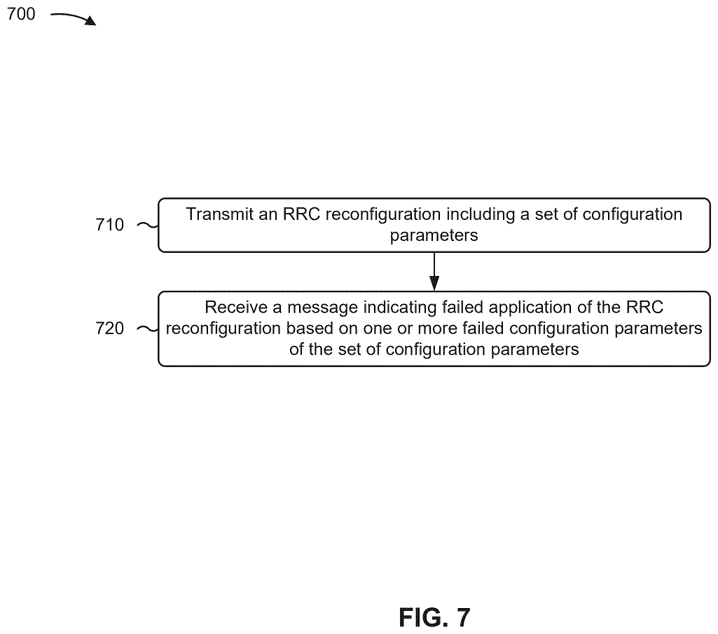

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with RRC reconfiguration error handling, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

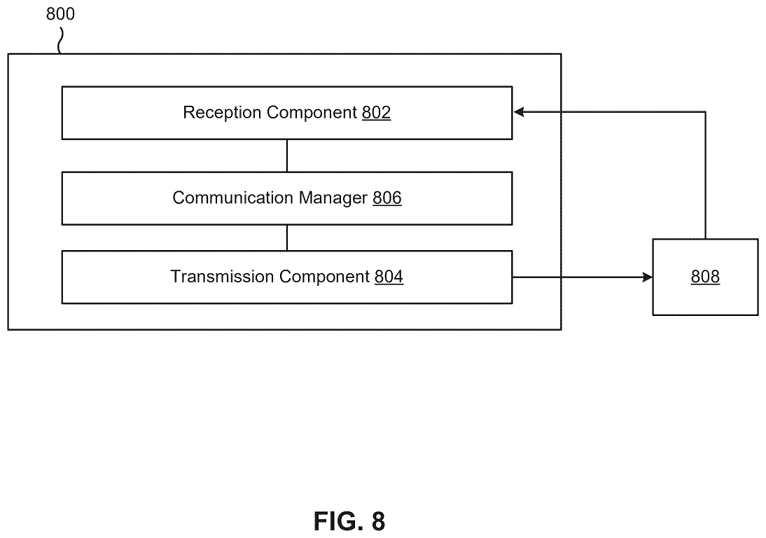

In some aspects, the UE 120 includes means for receiving, from a network node, an RRC reconfiguration including a set of configuration parameters; or means for transmitting, to the network node 110, a message indicating failed application of the RRC reconfiguration based on one or more failed configuration parameters of the set of configuration parameters. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

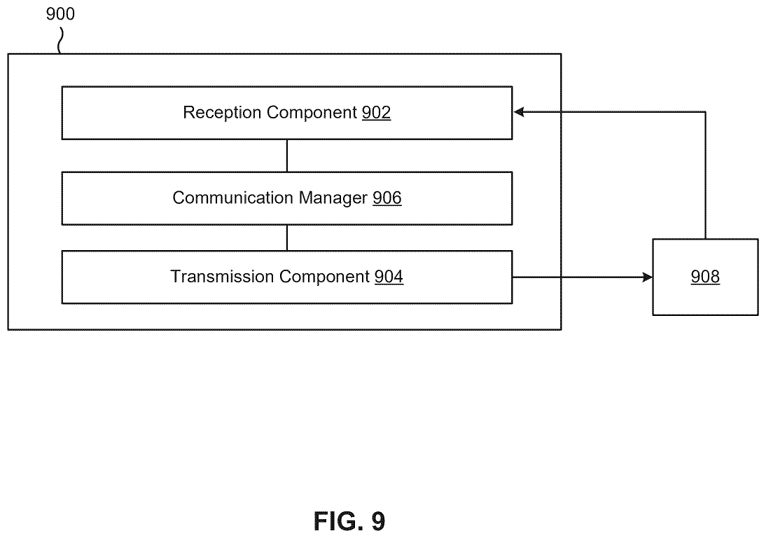

In some aspects, the network node 110 includes means for transmitting, to a UE 120, an RRC reconfiguration including a set of configuration parameters; or means for receiving, from the UE 120, a message indicating failed application of the RRC reconfiguration based on one or more failed configuration parameters of the set of configuration parameters. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

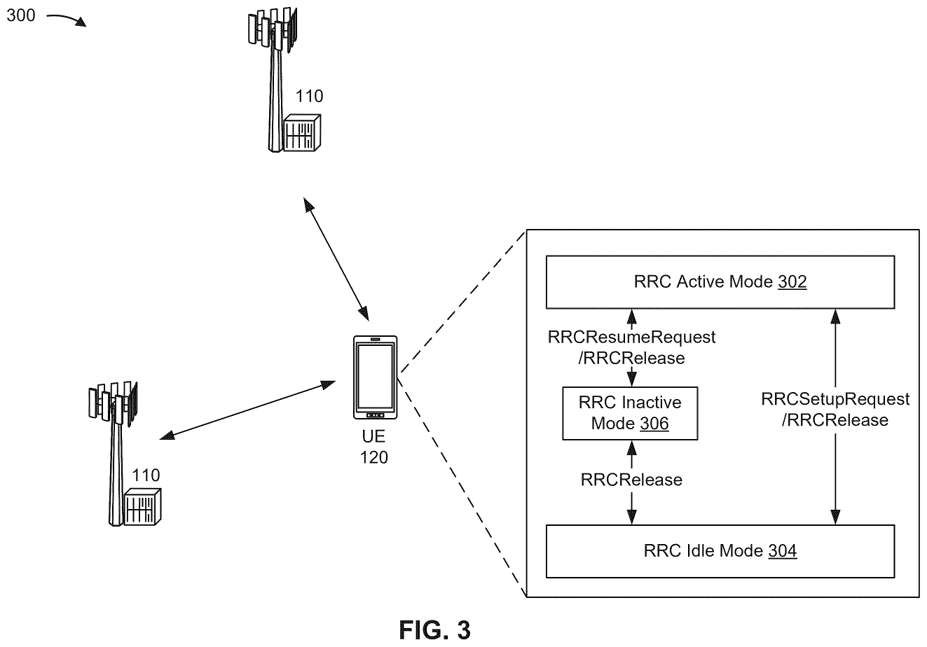

FIG. 3 illustrates an example 300 of a wireless network (e.g., wireless network 100) in which a UE (e.g., a UE 120) may support additional communication modes. The UE may be communicatively connected with one or more network nodes 110 in the wireless network. For example, the UE may be connected to the one or more network nodes 110 in a dual connectivity configuration. In this case, a first network node 110 may serve the UE as a master node and a second network node 110 may serve the UE as a secondary node.

As illustrated in FIG. 3, the UE may support a connected communication mode (e.g., an RRC active mode 302, which may also be referred to as an RRC_CONNECTED mode), an idle communication mode (e.g., an RRC idle mode 304 which may also be referred to as an RRC_IDLE mode), and an inactive communication mode (e.g., an RRC inactive mode 306, which may also be referred to as an RRC_INACTIVE mode). RRC inactive mode 306 may functionally reside between RRC active mode 302 and RRC idle mode 304.

An RRC configuration may be responsible for establishing, maintaining, or releasing connections between the UE and the network node. Furthermore, the RRC configuration may specify how resources are allocated and optimized for the UE, thereby enabling efficient transitions between the communication modes. In some examples, the UE may transition between different modes based at least in part on various commands or communications received from the one or more network nodes 110. For example, the UE may transition from RRC active mode 302 or RRC inactive mode 306 to RRC idle mode 304 based at least in part on receiving an RRCRelease communication. As another example, the UE may transition from RRC active mode 302 to RRC inactive mode 306 based at least in part on receiving an RRCRelease with suspendConfig communication. As another example, the UE may transition from RRC idle mode 304 to RRC active mode 302 based at least in part on receiving an RRCSetupRequest communication. As another example, the UE may transition from RRC inactive mode 306 to RRC active mode 302 based at least in part on receiving an RRCResumeRequest communication.

When transitioning to RRC inactive mode 306, the UE or the one or more network nodes 110 may store a UE context (e.g., an access stratum (AS) context or higher-layer configurations). This permits the UE or the one or more network nodes 110 to apply the stored UE context when the UE transitions from RRC inactive mode 306 to RRC active mode 302 in order to resume communications with the one or more network nodes 110, which reduces latency of transitioning to RRC active mode 302 relative to transitioning to the RRC active mode 302 from RRC idle mode 304.

In some cases, the UE may communicatively connect with a new master node when transitioning from RRC idle mode 304 or RRC inactive mode 306 to RRC active mode 302 (e.g., a master node that is different from the last serving master node when the UE transitioned to RRC idle mode 304 or RRC inactive mode 306). In this case, the new master node may be responsible for identifying a secondary node for the UE in the dual connectivity configuration.

As indicated above, FIG. 3 is provided as an example. Other examples may differ from what is described with regard to FIG. 3.

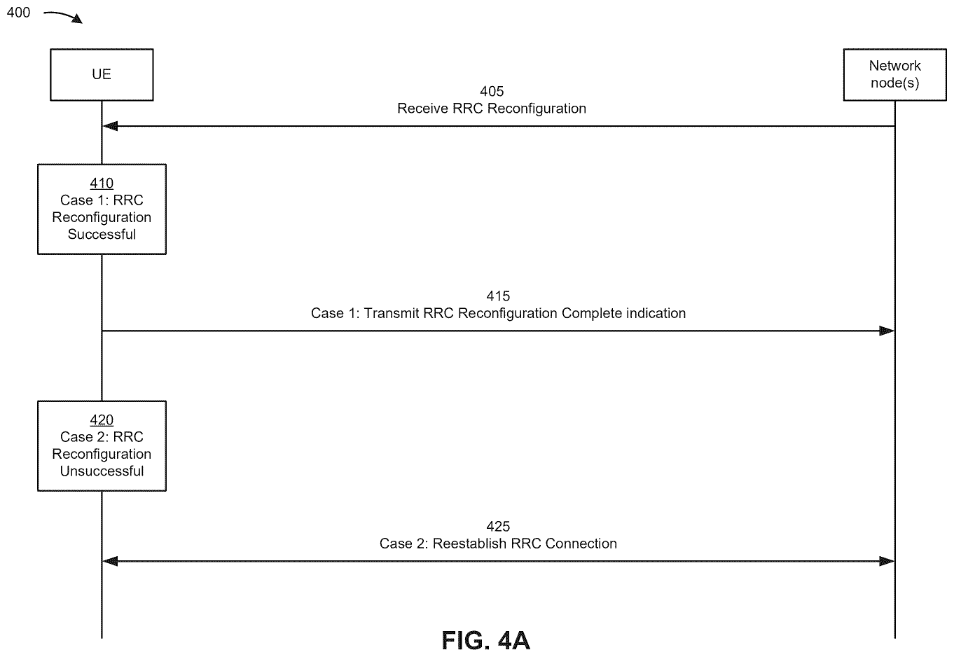

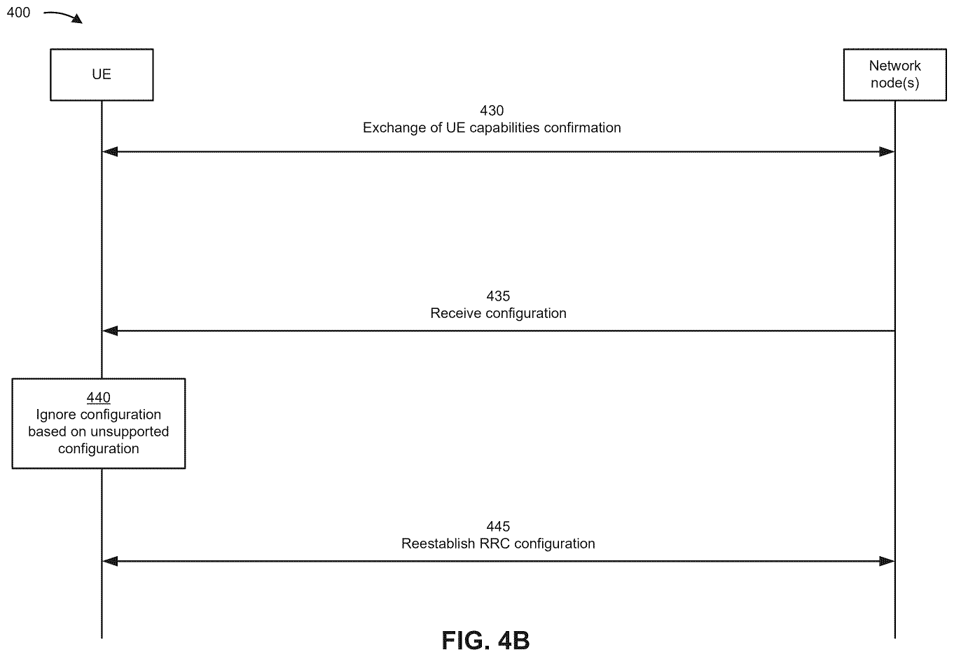

FIGS. 4A-4B are diagrams illustrating examples 400 of reconfiguration of an RRC configuration. As shown in FIGS. 4A-4B, a network node (e.g., network node 110) and a UE (e.g., UE 120) may communicate with one another. In some aspects, the network node and the UE may be part of a wireless network (e.g., wireless network 100). The UE and the network node may have established a wireless connection prior to operations shown in FIGS. 4A-4B.

In some examples, the network may utilize an RRC reconfiguration process to setup or modify an RRC configuration. For example, the network may perform RRC reconfiguration to establish, modify, or release connections, including RB or backhaul RLC channels, Uu relay RLC channels, a PC5 relay channel (e.g., a communication channel established over the PC5 interface, as part of a sidelink protocol), among other examples. Additionally, the network may modify an RRC connection to perform reconfiguration with a synchronization process, where the reconfiguration may occur with or without a security key refresh, or where the reconfiguration may be for handover or mobility considerations, with or without a random access procedure in a target cell. Furthermore, the network may modify an RRC connection to setup, modify, or release measurements, to add, modify, or release SCells or cell groups, to configure a conditional reconfiguration, to perform a lower layer triggered mobility (LTM) configuration, or to perform a multi-path configuration, among other examples. Additionally, in some examples, the RRC reconfiguration procedure may include a transfer of non-access stratum (NAS)-dedicated information to facilitate communication between the UE and a core network. For example, the NAS-dedicated information associated with the RRC reconfiguration message may include information associated with authentication, session management, or mobility management, thereby enabling continuous coordination between the RAN and core network layers. As a result, the network may adapt the RRC configuration to the UE's unique conditions or to network conditions, among other examples.

For example, the network may perform a UE-specific RRC reconfiguration that may focus on tailoring the connection parameters and resource allocations for the UE based on the UE's unique conditions or on the network conditions. In some examples, the UE may be in an RRC_CONNECTED mode to receive and configure a UE-specific RRC reconfiguration, where the RRC reconfiguration may be provided to the UE via an RRC configuration message, including an RRCReconfiguration message or an RRCRelease message (e.g., with or without a suspendConfig field), among other examples. Additionally, a UE-specific RRC reconfiguration may be a fixed configuration that is based on network-evaluated conditions rather than conditions that are local to the UE (e.g., network traffic, use case, vertical orientation, mobility speed, height, temperature, channel conditions, or the like). As a result, a UE-specific RRC reconfiguration may enable the network to optimize resource utilization and maintain QoS for diverse applications, including URLLC or eMBB, among other examples.

In some examples, the network may update a system information block (SIB) configuration (e.g., a broadcast configuration) associated with RRC reconfiguration, which may include modifications to timers, constants, or other parameters that impact how UEs manage their connections while in RRC_CONNECTED or RRC_INACTIVE modes. In some examples, an SIB configuration may be applicable for UEs in an RRC_IDLE mode (e.g., prior to the UE entering an RRC_CONNECTED mode). An SIB-based configuration may be applied on a cell-specific basis (e.g., rather than a UE-specific basis), which may enable updates to one or more UEs located within a cell coverage, and the SIB-based configuration may convey cell-specific network capabilities. Additionally, an SIB-based configuration may include a default configuration that is not specific to radio conditions associated with one or more UEs (e.g., the default configuration may not distinguish between UEs located at a cell edge as opposed to a cell center) or other UE-specific conditions, including network traffic, vertical orientation, use case, or the like. In some examples, however, there may be different default configurations associated with different UE types, including for RedCap or non-RedCap UE types.

As shown in FIG. 4A, and by reference number 405, the network node may transmit, and the UE may receive, a message including an RRC reconfiguration. In some examples, the network node may transmit the RRC reconfiguration in order to modify an RRC configuration or an RRC connection at the UE.

As shown by reference number 410, in a first case, the UE may successfully apply the RRC reconfiguration. As shown by reference number 415, in the first case, the UE may transmit, and the network node may receive, an indication that the RRC reconfiguration was successfully applied at the UE. Accordingly, the network node may apply the updated configuration parameters at the network node, thereby ensuring synchronization between the UE and the network node. As a result, the network may activate any newly configured features (e.g., updated radio bearers, mobility settings, dual connectivity, or the like) and continue communication using the updated configuration.

As shown by reference number 420, in a second case, the UE may unsuccessfully apply the RRC reconfiguration. For example, the UE may be unable to apply one or more configuration parameters associated with the RRC reconfiguration, rendering the RRC reconfiguration effectively inoperative. In some examples, the UE may be unable to apply all or part of the RRC reconfiguration due to unsupported or incorrect configurations, synchronization failure, integrity check failures, radio link quality issues (e.g., poor radio link conditions), hardware limitations, a thermal state or UE-specific power levels (e.g., high-throughput or processor-intensive operations may be curtailed due to rises in temperature or relatively low battery levels), or the UE operating in an MSIM mode (e.g., where active traffic on a secondary SUB results in reduced capability for the primary SUB).

As shown by reference number 425, in the second case, where the UE unsuccessfully applies the RRC reconfiguration, or where the UE receives a problematic RRC reconfiguration, the UE may trigger re-establishment of the RRC connection. After connection re-establishment, the network node may retransmit the RRC reconfiguration. However, the UE may remain unable to successfully apply part or all of the retransmitted RRC reconfiguration.

As shown in FIG. 4B, a UE may receive an RRC reconfiguration that includes one or more configuration parameters that are unsupported by the UE. As shown by reference number 430, where the UE is in an RRC_CONNECTED mode, the UE and the network may exchange capability information. For example, the UE may include capability signaling indicating that the UE supports small data transmission (SDT) features. As shown by reference number 435, the network node may transmit, and the UE may receive, a configuration, including one or more configuration parameters. For example, the network node may transmit, and the UE may receive, an SDT configuration, including configuration parameter SDT-Config-r17, which includes SDT-CG-Config-r17.

As shown by reference number 440, however, where the UE is unable to apply the configuration, the UE may ignore the received configuration. For example, the UE may not support SDT-CG-Config-r17 (e.g., the UE may support other SDT features, configurations, and/or configuration parameters), or the network node may have provided an incorrect configuration (e.g., the network node may have incorrectly considered the UE's capabilities). Accordingly, and as shown by reference number 445, the UE may initiate an RRC connection re-establishment procedure. Additionally, or alternatively, the UE may transmit, to the network node, a UE capability update that indicates an updated set of capabilities supported by the UE, which may or may not be considered by the network node.

As a result, where the UE is unable to apply part of the network-provided RRC reconfiguration, the RRC reconfiguration may be effectively inoperative. Although the network node may retransmit the RRC reconfiguration after RRC connection re-establishment, the UE may remain unable to successfully apply part or all of the retransmitted RRC reconfiguration. Accordingly, the UE may continue to receive an RRC reconfiguration that the UE is unable to apply, resulting in a repeatedly unsuccessful RRC reconfiguration procedure.

As indicated above, FIGS. 4A-4B are provided as examples. Other examples may differ from what is described with respect to FIGS. 4A-4B.

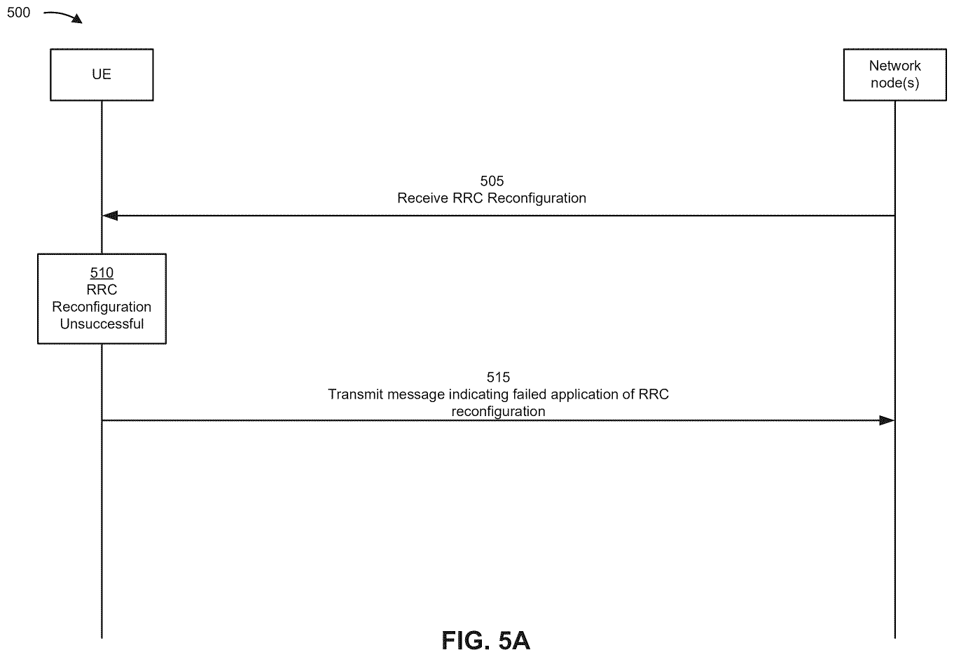

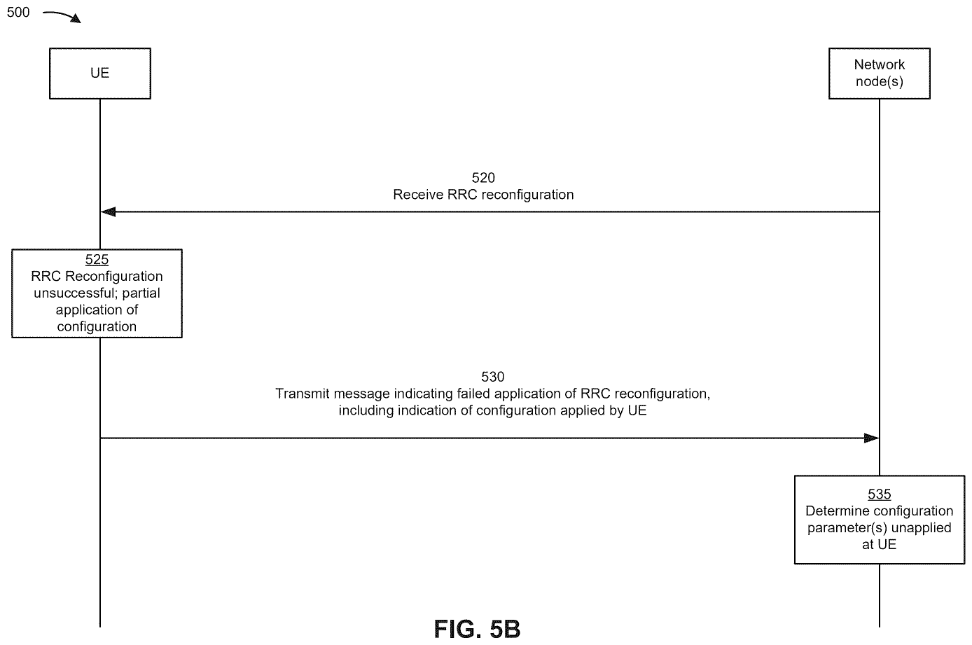

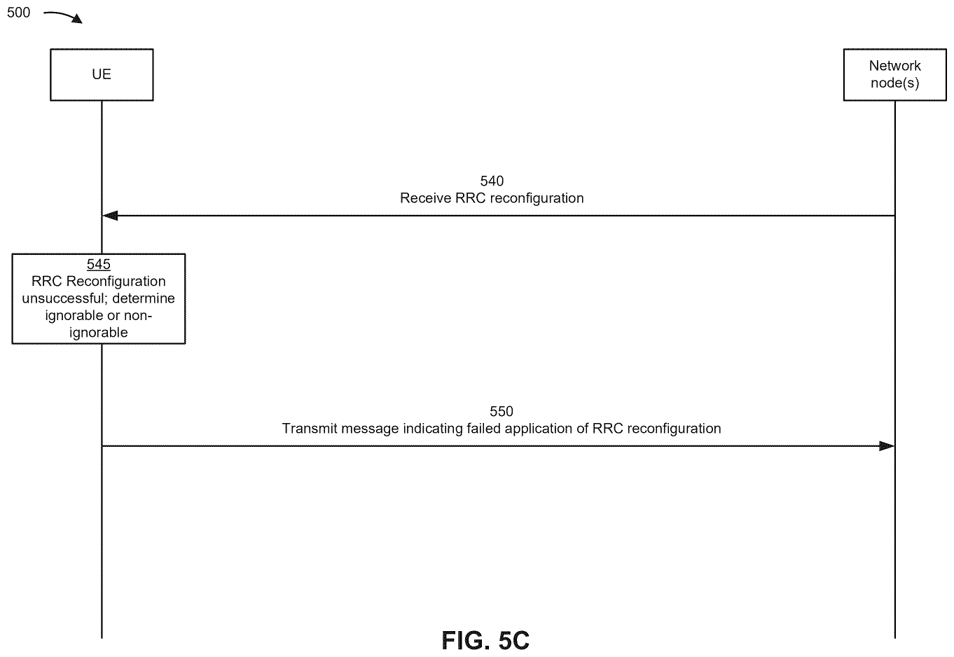

FIGS. 5A-5C are diagrams of an example 500 associated with RRC reconfiguration error handling. As shown in FIGS. 5A-5C, a network node (e.g., network node 110) may communicate with a UE (e.g., UE 120). In some aspects, the network node and the UE may be part of a wireless network (e.g., wireless network 100). In some aspects, actions described as being performed by the network node may be performed by multiple different network nodes. For example, configuration actions may be performed by a first network node (e.g., a CU or a DU), and radio communication actions may be performed by a second network node (e.g., a DU or an RU). The UE and the network node may have established a wireless connection prior to operations shown in FIGS. 5A-5C.

In some aspects, where the UE receives, from the network node, an RRC reconfiguration including a set of reconfiguration parameters, the UE may transmit, to the network node, a message indicating failed application of the RRC reconfiguration based on one or more failed configuration parameters. Additionally, the UE may apply one or more successful configuration parameters and may indicate, to the network node, the failed configuration parameters or the successful configuration parameters. As a result, the UE may potentially avoid initiating an RRC connection re-establishment procedure.

As shown by reference number 505, the network node may transmit (directly or via one or more other network nodes), and the UE may receive, RRC reconfiguration information. In some aspects, the RRC reconfiguration information may include an indication of one or more configuration parameters for selection by the UE, or explicit configuration information for the UE to use to configure the UE, among other examples. In some aspects, the configuration information may indicate that the UE is to update one or more configuration parameters (e.g., to establish, modify, or release one or more channel connections).

As shown by reference number 510, the UE may fail in applying one or more of the RRC reconfiguration parameters (e.g., application of the RRC reconfiguration may be unsuccessful). For example, the UE may be unable to apply one or more configuration parameters associated with the RRC reconfiguration. In some examples, the UE may be unable to apply part of the RRC reconfiguration due to unsupported or incorrect configurations, synchronization failure, integrity check failures, radio link quality issues (e.g., poor radio link conditions), hardware limitations, a thermal state or UE-specific power levels (e.g., high-throughput or processor-intensive operations may be curtailed due to rises in temperature or relatively low battery levels), or the UE operating in an MSIM mode (e.g., where active traffic on a secondary SUB results in reduced capability for the primary SUB).

As shown by reference number 515, the UE may transmit, and the network node may receive, a message indicating failed application of the RRC reconfiguration. In some aspects, the message may indicate the one or more failed (e.g., unapplied) configuration parameters. Alternatively, the UE may indicate that one or more configuration parameters were not applied, without identifying the failed configuration parameters, thereby potentially reducing the transmission overhead. In some aspects, the message may indicate a rejection of the RRC configuration based on the failed application of one or more configuration parameters, where the rejection indicates that the UE is applying a previously-obtained RRC configuration or a previously-applied RRC configuration.

In some aspects, the UE may obtain a configuration indicating one or more conditions for transmitting the message indicating failed application of the RRC reconfiguration. Accordingly, the UE may transmit, to the network node, an RRC re-establishment request based on a determination that the one or more conditions are satisfied or are not satisfied.

Additionally, or alternatively, the UE may be capable of supporting one or more of the configuration parameters associated with the RRC configuration, and the UE may indicate, to the network node, one or more of the successfully-applied configuration parameters or one or more of the failed configuration parameters. In some aspects, where the UE is capable of applying or complying with one or more of the received configuration parameters, the UE may skip a configured transmission (e.g., according to a previously obtained configuration) of an RRC re-establishment request. As a result, the quantity of potentially unsuccessful, repeated RRC reconfiguration messages may be reduced, thereby improving spectral efficiency or reducing network traffic.

In some aspects, the UE may transmit, and the network node may receive, capability information that indicates support for reporting a failed application of one or more RRC reconfigurations. Additionally, or alternatively, the UE may receive, from the network node, an updated RRC reconfiguration, including an updated set of configuration parameters. For example, where the network node receives a message indicating a failed RRC reconfiguration, the network node may transmit, and the UE may receive, the updated RRC reconfiguration. As a result, the network node may adapt the updated RRC reconfiguration to comport with the capabilities of the UE, thereby increasing the probability that the UE will be capable of applying the updated RRC reconfiguration.

In some aspects, the message may include a bitmap identifying one or more of the one or more failed configuration parameters and one or more of the one or more successful configuration parameters. Additionally, each configuration parameter may be included in a configuration parameter group, where the message transmitted to the network node indicates each configuration parameter group that includes one or more failed configuration parameter groups. In some aspects, one or more fields associated with each configuration parameter may be grouped into field groups, where the UE may indicate failure for a group based on one or more fields (e.g., associated with one or more failed configuration parameters) being associated with a failed or unsuccessful application of the one or more respective configuration parameters.

In some additional aspects, the granularity of the indications included in the message transmitted from the UE may depend on a configuration type associated with one or more respective configuration parameters. For example, the UE may report failures for certain configuration types (e.g., associated with one or more respective configuration parameters), but the UE may not report a failed application for certain other configuration types.

As shown in FIG. 5B, and by reference number 520, the network node may transmit, and the UE may receive, an RRC reconfiguration. As shown by reference number 525, the UE may be capable of partially applying the RRC reconfiguration (e.g., successfully applying one or more of the configuration parameters). As a result, and as shown by reference number 530, the UE may transmit, and the network node may receive, a message indicating a failed application of the RRC reconfiguration, but including an indication of one or more configuration parameters that were applied by the UE. As shown by reference number 535, the network node may determine one or more configuration parameters that were not applied at the UE, based on the received message indicating the configuration applied at the UE. In other words, the UE may transmit an echo of the applied configuration to the network node, and the network node may determine the configuration parameters that were not applied at the UE.

As shown in FIG. 5C, in some aspects, one or more of the configuration parameters of the RRC reconfiguration are associated with an ignorable parameter type or with a non-ignorable parameter type.

As shown by reference number 540, the network node may transmit, and the UE may receive, an RRC reconfiguration. In some aspects, each configuration parameter associated with the RRC reconfiguration may be associated with an ignorable parameter set or a non-ignorable parameter set.

As shown by reference number 545, where the RRC reconfiguration is unsuccessful at the UE (e.g., the UE is unable to successfully apply one or more configuration parameters), the UE may determine whether the failed configuration parameters associated with the RRC reconfiguration are associated with an ignorable parameter type or are associated with a non-ignorable parameter type.

In some aspects, the network node may indicate, to the UE, one or more configuration parameters (e.g., associated with an RRC reconfiguration) as associated with an ignorable parameter type or with a non-ignorable parameter type. Additionally, or alternatively, the UE may have previously obtained an indication that indicates one or more configuration parameters (e.g., associated with an RRC reconfiguration) as being associated with an ignorable parameter type or with a non-ignorable parameter type. Additionally, or alternatively, the RRC reconfiguration received from the network node may indicate one or more configuration parameters as associated with an ignorable parameter type or with a non-ignorable parameter type.

In some aspects, the UE or the network node may identify a set of need codes that indicates one or more ignorable parameter types that may be associated with one or more configuration parameters, fields, or the like that are associated with an RRC reconfiguration. For example, the UE or the network node may identify the one or more need codes via autonomous system number (ASN) (e.g., ASN.1) signaling, where the need code may be identified independently or in conjunction with additional need codes that specify the behavior of the UE when certain option fields are present or absent in signaling message. Additionally, for example, the set of need codes may be obtained or identified from a wireless communication standard. Furthermore, the wireless communication standard may include an added (e.g., new) need code that may indicate a field, configuration, or configuration parameter that the UE may ignore, where the UE is unable to apply the field, configuration, or configuration parameter. For example, the new added or new need code may be associated with ASN.1 signaling.

As shown by reference number 550, the UE may transmit, and the network node may receive, a message indicating failed application of the RRC configuration. In some aspects, the UE indicates the failed application of the RRC configuration regardless of whether any of the failed configuration parameters are associated with an ignorable parameter type, thereby ensuring that the network node is informed of any failed RRC configuration. Additionally, or alternatively, the UE may not indicate, to the network node, where the UE ignores a configuration parameter associated with an ignorable parameter type, but the UE may indicate, to the network node, where it ignores a non-ignorable parameter type.

In some aspects, the UE may skip a configured transmission of an RRC re-establishment request based on a determination that each failed configuration parameter of an RRC reconfiguration is associated with an ignorable parameter type. For example, where the UE successfully applies configuration parameters associated with a non-ignorable parameter type or an ignorable parameter type, but the UE unsuccessfully applies configuration parameters associated with an ignorable parameter type, the UE may skip a configured transmission of an RRC re-establishment request. Additionally, in some aspects, the UE may transmit an RRC re-establishment request based on a determination that one or more failed configuration parameters are not associated with an ignorable parameter type. Additionally, or alternatively, the UE may transmit an RRC re-establishment request based on a determination that one or more failed configuration parameters are associated with a non-ignorable parameter type. For example, where the UE successfully applies configuration parameters associated with a non-ignorable parameter type or with an ignorable parameter type, but the UE unsuccessfully applies configuration parameters associated with a non-ignorable parameter type, the UE may transmit an RRC re-establishment request to the network node.

As described herein, where a UE is unable to successfully apply an RRC reconfiguration received from a network node, the UE may indicate the failed application of the RRC reconfiguration. In some examples, the described techniques can be used to efficiently indicate an unsuccessful application of all or part of an RRC reconfiguration received at a UE, thereby reducing latency due to the potential repetition of RRC reconfigurations to the UE. Additionally, the described techniques may be used to improve spectral efficiency or reduce network traffic by reducing the quantity of potentially unsuccessful RRC reconfiguration messages transmitted to one or more UEs in the network. Furthermore, by transmitting a bitmap identifying the failed configuration parameters, the UE may reduce transmission overhead relative to the transmission of a message indicating the identity of each failed configuration parameter and any accompanying information. In some examples, where each configuration parameter is associated with an ignorable or a non-ignorable parameter type, the UE may skip an RRC re-establishment request for configuration parameters of relatively less importance or lower priority, thereby conserving power and reducing network congestion due to a reduced quantity of communications between the UE and the network node.

As indicated above, FIGS. 5A-5C are provided as examples. Other examples may differ from what is described with respect to FIGS. 5A-5C.

FIG. 6 is a diagram illustrating an example process 600 performed, for example, at a UE or an apparatus of a UE. Example process 600 is an example where the apparatus or the UE (e.g., UE 120) performs operations associated with RRC reconfiguration error handling.

As shown in FIG. 6, in some aspects, process 600 may include receiving, from a network node, an RRC reconfiguration including a set of configuration parameters (block 610). For example, the UE (e.g., using reception component 802 or communication manager 806, depicted in FIG. 8) may receive, from a network node, an RRC reconfiguration including a set of configuration parameters, as described above.

As further shown in FIG. 6, in some aspects, process 600 may include transmitting, to the network node, a message indicating failed application of the RRC reconfiguration based on one or more failed configuration parameters of the set of configuration parameters (block 620). For example, the UE (e.g., using transmission component 804 or communication manager 806, depicted in FIG. 8) may transmit, to the network node, a message indicating failed application of the RRC reconfiguration based on one or more failed configuration parameters of the set of configuration parameters, as described above.

Process 600 may include additional aspects, such as any single aspect or any combination of aspects described below or in connection with one or more other processes described elsewhere herein.

In a first aspect, the message includes an indication of the one or more failed configuration parameters of the set of configuration parameters.

In a second aspect, alone or in combination with the first aspect, process 600 includes skipping a configured transmission of an RRC re-establishment request based on a successful application of one or more successful configuration parameters of the set of configuration parameters.

In a third aspect, alone or in combination with one or more of the first and second aspects, the message includes a bitmap identifying one or more of the one or more failed configuration parameters of the set of configuration parameters and one or more successful configuration parameters of the set of configuration parameters.

In a fourth aspect, alone or in combination with one or more of the first through third aspects, each configuration parameter of the set of configuration parameters is included in a configuration parameter group, and the message indicates each configuration parameter group of the one or more configuration parameter groups that includes one or more failed configuration parameters.

In a fifth aspect, alone or in combination with one or more of the first through fourth aspects, each configuration parameter of the set of configuration parameters is associated with an ignorable parameter type of a set of ignorable parameter types or a non-ignorable parameter type of a set of non-ignorable parameter types.

In a sixth aspect, alone or in combination with one or more of the first through fifth aspects, the message indicates a non-ignorable failed application of the RRC reconfiguration based on a determination that one or more of the one or more failed configuration parameters of the set of configuration parameters is associated with a non-ignorable parameter type.

In a seventh aspect, alone or in combination with one or more of the first through sixth aspects, process 600 includes skipping a configured transmission of an RRC re-establishment request based on a determination that each failed configuration parameter of the set of configuration parameters is associated with an ignorable parameter type.

In an eighth aspect, alone or in combination with one or more of the first through seventh aspects, process 600 includes transmitting an RRC re-establishment request based on a determination that one or more failed configuration parameters of the set of configuration parameters is not associated with an ignorable parameter type.

In a ninth aspect, alone or in combination with one or more of the first through eighth aspects, process 600 includes identifying a set of need codes, including an ignorable need code that indicates the set of ignorable parameter types.

In a tenth aspect, alone or in combination with one or more of the first through ninth aspects, process 600 includes applying a previously-obtained RRC configuration based on transmission of the message indicating failed application of the RRC reconfiguration.

In an eleventh aspect, alone or in combination with one or more of the first through tenth aspects, process 600 includes receiving, from the network node, an updated RRC reconfiguration including an updated set of configuration parameters.

In a twelfth aspect, alone or in combination with one or more of the first through eleventh aspects, the message includes an identification of each successful configuration parameter of the set of configuration parameters that was successfully applied by the UE.

In a thirteenth aspect, alone or in combination with one or more of the first through twelfth aspects, process 600 includes obtaining a configuration indicating one or more conditions for transmission of the message, wherein the one or more conditions is associated with the UE, and transmitting, to the network node, an RRC re-establishment request based on a determination that the one or more conditions are not satisfied.

In a fourteenth aspect, alone or in combination with one or more of the first through thirteenth aspects, process 600 includes transmitting, to the network node, capability information that indicates support for reporting a failed application of one or more received RRC reconfigurations.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with RRC reconfiguration error handling.

As shown in FIG. 7, in some aspects, process 700 may include transmitting, to a UE, an RRC reconfiguration including a set of configuration parameters (block 710). For example, the network node (e.g., using transmission component 904 or communication manager 906, depicted in FIG. 9) may transmit, to a UE, an RRC reconfiguration including a set of configuration parameters, as described above.

As further shown in FIG. 7, in some aspects, process 700 may include receiving, from the UE, a message indicating failed application of the RRC reconfiguration based on one or more failed configuration parameters of the set of configuration parameters (block 720). For example, the network node (e.g., using reception component 902 or communication manager 906, depicted in FIG. 9) may receive, from the UE, a message indicating failed application of the RRC reconfiguration based on one or more failed configuration parameters of the set of configuration parameters, as described above.

Process 700 may include additional aspects, such as any single aspect or any combination of aspects described below or in connection with one or more other processes described elsewhere herein.

In a first aspect, the message includes an indication of the one or more failed configuration parameters of the set of configuration parameters.

In a second aspect, alone or in combination with the first aspect, the message includes a bitmap identifying one or more of the one or more failed configuration parameters of the set of configuration parameters and one or more successful configuration parameters of the set of configuration parameters.

In a third aspect, alone or in combination with one or more of the first and second aspects, each configuration parameter of the set of configuration parameters is included in a configuration parameter group, and the message indicates each configuration parameter group of the one or more configuration parameter groups that includes at one or more failed configuration parameters.

In a fourth aspect, alone or in combination with one or more of the first through third aspects, each configuration parameter of the set of configuration parameters is associated with an ignorable parameter type of a set of ignorable parameter types or a non-ignorable parameter type of a set of non-ignorable parameter types.

In a fifth aspect, alone or in combination with one or more of the first through fourth aspects, the message indicates a non-ignorable failed application of the RRC reconfiguration.

In a sixth aspect, alone or in combination with one or more of the first through fifth aspects, process 700 includes identifying a set of need codes, including an ignorable need code that indicates the set of ignorable parameter types.

In a seventh aspect, alone or in combination with one or more of the first through sixth aspects, process 700 includes receiving an RRC re-establishment request associated with the message indicating failed application of the RRC reconfiguration.

In an eighth aspect, alone or in combination with one or more of the first through seventh aspects, process 700 includes transmitting, to the UE, an updated RRC reconfiguration including an updated set of configuration parameters based on receiving the message indicating failed application of the RRC reconfiguration.

In a ninth aspect, alone or in combination with one or more of the first through eighth aspects, the message includes an identification of each successful configuration parameter of the set of configuration parameters that was successfully applied by the UE.

In a tenth aspect, alone or in combination with one or more of the first through ninth aspects, process 700 includes receiving, from the UE, capability information that indicates support for reporting a failed application of one or more received RRC reconfigurations.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 5A-5C. Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive, from a network node, an RRC reconfiguration including a set of configuration parameters. The transmission component 804 may transmit, to the network node, a message indicating failed application of the RRC reconfiguration based on one or more failed configuration parameters of the set of configuration parameters.

The communication manager 806 may skip a configured transmission of an RRC re-establishment request based on a successful application of one or more successful configuration parameters of the set of configuration parameters.

The communication manager 806 may skip a configured transmission of an RRC re-establishment request based on a determination that each failed configuration parameter of the set of configuration parameters is associated with an ignorable parameter type.

The transmission component 804 may transmit an RRC re-establishment request based on a determination that one or more failed configuration parameters of the set of configuration parameters is not associated with an ignorable parameter type.

The reception component 802 may identify a set of need codes, including an ignorable need code that indicates the set of ignorable parameter types.

The communication manager 806 may apply a previously-obtained RRC configuration based on transmission of the message indicating failed application of the RRC reconfiguration.

The reception component 802 may receive, from the network node, an updated RRC reconfiguration including an updated set of configuration parameters.

The reception component 802 may obtain a configuration indicating one or more conditions for transmission of the message, wherein the one or more conditions is associated with the UE.

The transmission component 804 may transmit, to the network node, an RRC re-establishment request based on a determination that the one or more conditions are not satisfied.

The transmission component 804 may transmit, to the network node, capability information that indicates support for reporting a failed application of one or more received RRC reconfigurations.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 5A-5C. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a UE, an RRC reconfiguration including a set of configuration parameters. The reception component 902 may receive, from the UE, a message indicating failed application of the RRC reconfiguration based on one or more failed configuration parameters of the set of configuration parameters.

The reception component 902 may identify a set of need codes, including an ignorable need code that indicates the set of ignorable parameter types.

The reception component 902 may receive an RRC re-establishment request associated with the message indicating failed application of the RRC reconfiguration.

The transmission component 904 may transmit, to the UE, an updated RRC reconfiguration including an updated set of configuration parameters based on receiving the message indicating failed application of the RRC reconfiguration.

The reception component 902 may receive, from the UE, capability information that indicates support for reporting a failed application of one or more received RRC reconfigurations.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: receiving, from a network node, a radio resource control (RRC) reconfiguration including a set of configuration parameters; and transmitting, to the network node, a message indicating failed application of the RRC reconfiguration based on one or more failed configuration parameters of the set of configuration parameters.
Aspect 2: The method of Aspect 1, wherein the message includes an indication of the one or more failed configuration parameters of the set of configuration parameters.
Aspect 3: The method of any of Aspects 1-2, further comprising: skipping a configured transmission of an RRC re-establishment request based on a successful application of one or more successful configuration parameters of the set of configuration parameters.
Aspect 4: The method of any of Aspects 1-3, wherein the message includes a bitmap identifying one or more of the one or more failed configuration parameters of the set of configuration parameters and one or more successful configuration parameters of the set of configuration parameters.
Aspect 5: The method of any of Aspects 1-4, wherein each configuration parameter of the set of configuration parameters is included in a configuration parameter group, and wherein the message indicates each configuration parameter group of the one or more configuration parameter groups that includes one or more failed configuration parameters.
Aspect 6: The method of any of Aspects 1-5, wherein each configuration parameter of the set of configuration parameters is associated with an ignorable parameter type of a set of ignorable parameter types or a non-ignorable parameter type of a set of non-ignorable parameter types.
Aspect 7: The method of Aspect 6, wherein the message indicates a non-ignorable failed application of the RRC reconfiguration based on a determination that one or more of the one or more failed configuration parameters of the set of configuration parameters is associated with a non-ignorable parameter type.
Aspect 8: The method of Aspect 6, further comprising: skipping a configured transmission of an RRC re-establishment request based on a determination that each failed configuration parameter of the set of configuration parameters is associated with an ignorable parameter type.
Aspect 9: The method of Aspect 6, further comprising: transmitting an RRC re-establishment request based on a determination that one or more failed configuration parameters of the set of configuration parameters is not associated with an ignorable parameter type.
Aspect 10: The method of Aspect 6, further comprising: identifying a set of need codes, including an ignorable need code that indicates the set of ignorable parameter types.
Aspect 11: The method of Aspect 10, wherein the ignorable need code is associated with an update to a wireless communication standard.
Aspect 12: The method of any of Aspects 1-11, wherein the message indicating failed application of the RRC reconfiguration is transmitted based on a failure of all configuration parameters of the set of configuration parameters.
Aspect 13: The method of any of Aspects 1-12, further comprising: applying a previously-obtained RRC configuration based on transmission of the message indicating failed application of the RRC reconfiguration.
Aspect 14: The method of any of Aspects 1-13, further comprising: receiving, from the network node, an updated RRC reconfiguration including an updated set of configuration parameters.
Aspect 15: The method of any of Aspects 1-14, wherein the message includes an identification of each successful configuration parameter of the set of configuration parameters that was successfully applied by the UE.
Aspect 16: The method of any of Aspects 1-15, further comprising: obtaining a configuration indicating one or more conditions for transmission of the message, wherein the one or more conditions is associated with the UE; and transmitting, to the network node, an RRC re-establishment request based on a determination that the one or more conditions are not satisfied.
Aspect 17: The method of any of Aspects 1-16, further comprising: transmitting, to the network node, capability information that indicates support for reporting a failed application of one or more received RRC reconfigurations.
Aspect 18: A method of wireless communication performed by a network node, comprising: transmitting, to a user equipment (UE), a radio resource control (RRC) reconfiguration including a set of configuration parameters; and receiving, from the UE, a message indicating failed application of the RRC reconfiguration based on one or more failed configuration parameters of the set of configuration parameters.
Aspect 19: The method of Aspect 18, wherein the message includes an indication of the one or more failed configuration parameters of the set of configuration parameters.
Aspect 20: The method of any of Aspects 18-19, wherein the message includes a bitmap identifying one or more of the one or more failed configuration parameters of the set of configuration parameters and one or more successful configuration parameters of the set of configuration parameters.
Aspect 21: The method of any of Aspects 18-20, wherein each configuration parameter of the set of configuration parameters is included in a configuration parameter group, and wherein the message indicates each configuration parameter group of the one or more configuration parameter groups that includes at one or more failed configuration parameters.
Aspect 22: The method of any of Aspects 18-21, wherein each configuration parameter of the set of configuration parameters is associated with an ignorable parameter type of a set of ignorable parameter types or a non-ignorable parameter type of a set of non-ignorable parameter types.
Aspect 23: The method of Aspect 22, wherein the message indicates a non-ignorable failed application of the RRC reconfiguration.
Aspect 24: The method of Aspect 22, further comprising: identifying a set of need codes, including an ignorable need code that indicates the set of ignorable parameter types.
Aspect 25: The method of any of Aspects 18-24, wherein the ignorable need code is associated with an update to a wireless communication standard.
Aspect 26: The method of any of Aspects 18-25, further comprising: receiving an RRC re-establishment request associated with the message indicating failed application of the RRC reconfiguration.
Aspect 27: The method of any of Aspects 18-26, further comprising: transmitting, to the UE, an updated RRC reconfiguration including an updated set of configuration parameters based on receiving the message indicating failed application of the RRC reconfiguration.
Aspect 28: The method of any of Aspects 18-27, wherein the message includes an identification of each successful configuration parameter of the set of configuration parameters that was successfully applied by the UE.
Aspect 29: The method of any of Aspects 18-28, further comprising: receiving, from the UE, capability information that indicates support for reporting a failed application of one or more received RRC reconfigurations.
Aspect 30: The method of any of Aspects 18-29, wherein the message indicating failed application of the RRC reconfiguration is received based on a failure of all configuration parameters of the set of configuration parameters.
Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.
Aspect 32: An apparatus for wireless communication at a device, the apparatus comprising one or more memories and one or more processors coupled to the one or more memories, the one or more processors configured to cause the device to perform the method of one or more of Aspects 1-30.
Aspect 33: An apparatus for wireless communication, the apparatus comprising at least one means for performing the method of one or more of Aspects 1-30.
Aspect 34: A non-transitory computer-readable medium storing code for wireless communication, the code comprising instructions executable by one or more processors to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.
Aspect 36: A device for wireless communication, the device comprising a processing system that includes one or more processors and one or more memories coupled with the one or more processors, the processing system configured to cause the device to perform the method of one or more of Aspects 1-30.
Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.
Aspect 38: A device comprising a processing system that includes one or more processors and one or more code-storing memories coupled with the one or more processors, the processing system configured to cause the device to perform the method of one or more of Aspects 1-30.
Aspect 39: A device comprising a processing system that includes processor circuitry and code-storing memory circuitry, the processing system configured to cause the device to perform the method of one or more of Aspects 1-30.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, a radio resource control (RRC) reconfiguration including a set of configuration parameters; and
transmit, to the network node, a message indicating failed application of the RRC reconfiguration based on one or more failed configuration parameters of the set of configuration parameters.

2. The UE of claim 1, wherein the message includes an indication of the one or more failed configuration parameters of the set of configuration parameters.

3. The UE of claim 1, wherein the processing system is configured to cause the UE to:
skip a configured transmission of an RRC re-establishment request based on a successful application of one or more successful configuration parameters of the set of configuration parameters.

4. The UE of claim 1, wherein the message includes a bitmap identifying one or more of the one or more failed configuration parameters of the set of configuration parameters and one or more successful configuration parameters of the set of configuration parameters.

5. The UE of claim 1, wherein each configuration parameter of the set of configuration parameters is included in a configuration parameter group, and wherein the message indicates each configuration parameter group of the one or more configuration parameter groups that includes one or more failed configuration parameters.

6. The UE of claim 1, wherein each configuration parameter of the set of configuration parameters is associated with an ignorable parameter type of a set of ignorable parameter types or a non-ignorable parameter type of a set of non-ignorable parameter types.

7. The UE of claim 6, wherein the message indicates a non-ignorable failed application of the RRC reconfiguration based on a determination that one or more of the one or more failed configuration parameters of the set of configuration parameters is associated with a non-ignorable parameter type.

8. The UE of claim 6, wherein the processing system is configured to cause the UE to:
skip a configured transmission of an RRC re-establishment request based on a determination that each failed configuration parameter of the set of configuration parameters is associated with an ignorable parameter type.

9. The UE of claim 6, wherein the processing system is configured to cause the UE to:
transmit an RRC re-establishment request based on a determination that one or more failed configuration parameters of the set of configuration parameters is not associated with an ignorable parameter type.

10. The UE of claim 6, wherein the processing system is configured to cause the UE to:
identify a set of need codes, including an ignorable need code that indicates the set of ignorable parameter types.

11. The UE of claim 1, wherein the processing system is configured to cause the UE to:
apply a previously-obtained RRC configuration based on transmission of the message indicating failed application of the RRC reconfiguration.

12. The UE of claim 1, wherein the message includes an identification of each successful configuration parameter of the set of configuration parameters that was successfully applied by the UE.

13. The UE of claim 1, wherein the processing system is configured to cause the UE to:
obtain a configuration indicating one or more conditions for transmission of the message, wherein the one or more conditions is associated with the UE; and
transmit, to the network node, an RRC re-establishment request based on a determination that the one or more conditions are not satisfied.

14. The UE of claim 1, wherein the processing system is configured to cause the UE to:
transmit, to the network node, capability information that indicates support for reporting a failed application of one or more received RRC reconfigurations.

15. A network node, comprising:
a processing system that includes one or more processors and one or more code-storing memories coupled with the one or more processors, the processing system configured to cause the network node to:
transmit, to a user equipment (UE), a radio resource control (RRC) reconfiguration including a set of configuration parameters; and
receive, from the UE, a message indicating failed application of the RRC reconfiguration based on one or more failed configuration parameters of the set of configuration parameters.

16. The network node of claim 15, wherein the message includes an indication of the one or more failed configuration parameters of the set of configuration parameters.

17. The network node of claim 15, wherein the message includes a bitmap identifying one or more of the one or more failed configuration parameters of the set of configuration parameters and one or more successful configuration parameters of the set of configuration parameters.

18. The network node of claim 15, wherein each configuration parameter of the set of configuration parameters is associated with an ignorable parameter type of a set of ignorable parameter types or a non-ignorable parameter type of a set of non-ignorable parameter types.

19. The network node of claim 15, wherein the processing system is configured to cause the network node to:
transmit, to the UE, an updated RRC reconfiguration including an updated set of configuration parameters based on receiving the message indicating failed application of the RRC reconfiguration.

20. A method of wireless communication performed by a user equipment (UE), comprising:
receiving, from a network node, a radio resource control (RRC) reconfiguration including a set of configuration parameters; and
transmitting, to the network node, a message indicating failed application of the RRC reconfiguration based on one or more failed configuration parameters of the set of configuration parameters.
